(19) United States
(12) Patent Application Publication
(10) Pub. No.: US 2020/0096481 A1
(43) Pub. Date: Mar. 26, 2020

(54) IMPACT ECHO DETECTION SYSTEM

(71) Applicant: CENTRAL RESEARCH INSTITUTE OF BUILDING AND CONSTRUCTION CO. LTD., BEIJING CITY (CN)

(72) Inventors: XINGBIN ZHANG, BEIJING CITY (CN); ZHONG ZHANG, BEIJING CITY (CN); SHA FANG, BEIJING CITY (CN); GUANQIAO ZHAO, BEIJING CITY (CN)

(21) Appl. No.: 16/620,020

(22) PCT Filed: Jun. 5, 2018
(86) PCT No.: PCT/CN2018/089865

§ 371 Date: Dec. 6, 2019

(30) Foreign Application Priority Data
Jun. 6, 2017 (CN) 201710417306.0

(51) Int. Cl. G01N 29/04; G01N 29/46; G01B 17/02; G01M 7/08

(52) U.S. Cl. CPC G01N 29/045; G01N 29/46; E02D 33/00; G01M 7/08; G01N 2291/02854; G01B 17/02

(57) ABSTRACT

An impact echo detection system including a fixed mount, an impact source, an elastic connection member, a transducer, and an acquisition and analysis device is provided. The fixed mount includes a frame and support rods. The support rods are fixed to the frame, which is passed through by the support rods. A middle portion of the elastic connection member passes through a through hole in the impact source, and is fixed to the impact source. Two ends of the elastic connection member are respectively connected to the fixators of the frame. The transducer is disposed at a periphery of the fixed mount with one end abuts against a surface of a medium to be tested and another end connects the acquisition and analysis device. The acquisition and analysis device analyzes the received impact echo data measured by the transducer to obtain analysis results.

The present application claims priority to the China Patent Application No. 200910417306.0, entitled “Impact Echo Detection System”, filed on Jun. 6, 2017, the entire contents of which is incorporated herein by reference.

### FIELD OF THE DISCLOSURE

The present disclosure relates to the field of non-destructive detection technology, and more particularly, to an impact echo detection system.

### BACKGROUND OF THE DISCLOSURE

Impact echo detection technology is an emerging technology in the field of non-destructive detection. The impact echo detection technology has the characteristics of low energy operation, wide applicability and all while being user-friendly, which has been widely used in the field of non-destructive detection of concrete and pile foundations.

However, there also exists many deficiencies in prior art of the impact echo detection methods. For instance, the echo generated by the impactor may have poor directivity, and the waveform obtained by signal acquisition system may lack sufficient accuracy, which both significantly affect accuracy and precision of detection results.

### SUMMARY OF THE DISCLOSURE

The embodiment of the present disclosure provides an impact echo detection system, thereby effectively improving the accuracy and precision of detection.

The present disclosure provides an impact echo detection system, which consists of the several apparatus as follow: an impactor, a fixed mount, an elastic connector, one or more transducers, and an acquisition and analysis device.

The fixed mount comprises: a frame and support rods; wherein the support rods are fixed to the frame, which is passed through by the support rods; a bottom portion of the support rod abuts against a surface of a medium to be tested; an impact source bombardment space is disposed at a middle portion of the frame to allow the impact source and the elastic connector to pass through; and fixators are respectively disposed on two opposite sides of an inner wall of the frame.

The through hole is formed on the impact source to allow the elastic connector through the impact source.

A middle portion of the elastic connector is fixed to the impact source, which is passed through by the middle portion of the elastic connector through the through hole in the impact source, and two ends of the elastic connector are respectively connected to the fixators on the inner wall of the frame.

The transducer is disposed at a periphery of the fixed mount, wherein one end of the transducer abuts against a surface of the medium to be tested, and another end is connected to the acquisition and analysis device. The transducer is configured to measure impact echo data when the impact source connected to the elastic connector hits the surface of the medium to be tested, and to send the impact echo data to the acquisition and analysis device.

The acquisition and analysis device is configured to analyze the received impact echo data to obtain an analysis result.

One end of the fixator distant from the elastic connector passes through the frame, and is fixed to the frame by an adjustable bolt; and a force borne by the connected elastic connector is adjusted by a movement of the adjustable bolt in a horizontal direction.

A hook structure for fixing the elastic connector is disposed at a joint of the fixators and the elastic connector.

An end of the support rod connected to the frame is threaded, and is fixed to the frame by a nut.

The acquisition and analysis device further comprises an acquisition box and an analyzer.

The acquisition box is configured to receive the impact echo data from the transducer and to send the received impact echo data to the analyzer.

The analyzer is configured to display the received impact echo data through a time domain curve and transform the time domain curve into a frequency domain curve based on the Fast Fourier Transform to determine a thickness of the medium to be tested and a wave speed of the impact echo; wherein the analyzer is further configured to receive parameters input by user.

The acquisition box is provided with a USB data acquisition card (DAQ).

The USB DAQ is connected to the transducer and the USB interface of the analyzer, which could send and receive an impact-echo signal, respectively.

The transducer is an acceleration sensor or a displacement sensor.

The impact source is a steel ball having a diameter from 2 to 10 mm.

The elastic connector is a rubber band.

The fixed mount is made of a stainless steel.

In the embodiment of the present disclosure, since the impact source is disposed in the middle of the fixed mount and the impact source is connected to the fixed mount through the elastic connector, when the impact echo detection is required, the impact source may be driven by the elastic connector to quickly hit the surface of the medium to be tested (instantaneous single contact) and generates an impact echo inside the medium; the echo will then gradually decay after multiple reflections and the transducer sends the measured impact echo to the acquisition and analysis device, so that the acquisition and analysis device can conduct analysis according to the received impact echo to obtain an analysis result. Consequently, a specific position and size of a defect inside the medium can be detected, and an accuracy of the defect detection can be effectively improved so as to allow for wider applicability in the detection of defects inside the medium. Moreover, the impact echo detection system of the present disclosure is of a simple structure, integrates simplicity and portability, and possesses excellent directivity.

### BRIEF DESCRIPTION OF THE DRAWINGS

In order to more clearly illustrate the embodiments of the present disclosure or the technical solutions in the prior art, the drawings to be used in the embodiments or the prior art description will be briefly described below. Obviously, the drawings in the following description are only a certain embodiment of the present disclosure, and other drawings can be obtained according to the drawings without any creative work for those skilled in the art.

FIG. 1 is a schematic diagram showing an overall structure and working principle of an impact echo detection system according to an embodiment of the present disclosure.

FIG. 2 is a top plan view of a fixed mount according to the embodiment of the present disclosure.

FIG. 3 is a side elevational view of the fixed mount according to the embodiment of the present disclosure.

### DETAILED DESCRIPTION OF THE EXEMPLARY EMBODIMENTS

The technical solutions in the embodiments of the present disclosure are clearly and completely described in the following with reference to the drawings in the embodiments of the present application. It is obvious that the described embodiments are only a part of the embodiments of the present application, and not all of the embodiments. All other embodiments obtained by a person of ordinary skill in the art based on the embodiments of the present application without departing from the inventive scope are the scope of the present application.

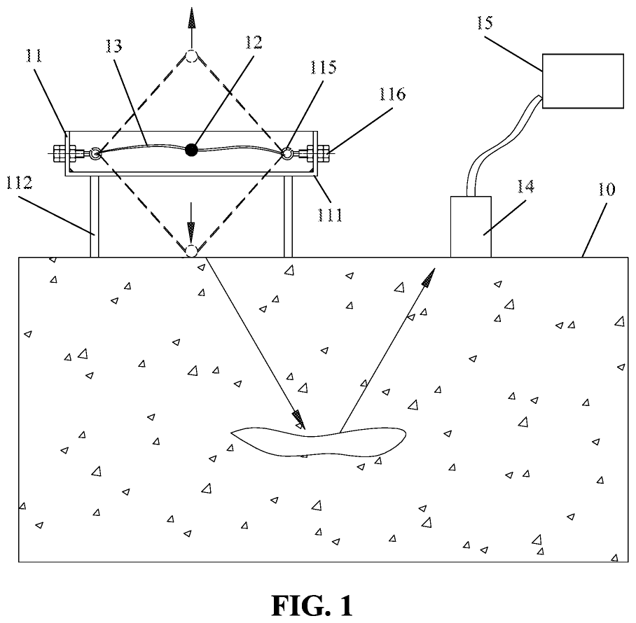

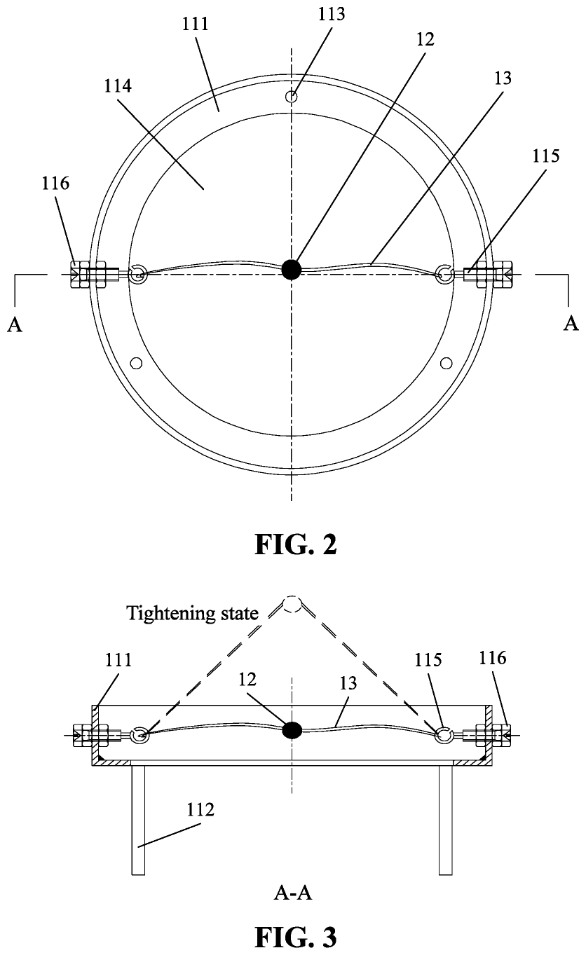

FIG. 1 is a schematic diagram showing the overall structure and working principle of an impact echo detection system according to an embodiment of the present disclosure, FIG. 2 is a top plan view of a fixed mount according to the embodiment of the present disclosure, and FIG. 3 is a side elevational view of the fixed mount according to the embodiment of the present disclosure. As shown in FIGS. 1 to 3, the impact echo detection system provided by the present disclosure consists of the several apparatus as follow: a fixed mount 11, an impact source 12, an elastic connector 13, one or more transducers 14, and an acquisition and analysis device 15.

The fixed mount 11 comprises: a frame 111 and support rods 112; wherein support rod through holes 113 are formed on the frame 111 and are passed through by the support rods 112, and the support rods 112 is fixed to the frame 111, which is passed through by the support rod through the support rod through holes 113; a bottom portion of the support rod 112 abuts against a surface of a medium to be tested 10; a middle portion of the frame 111 is provided with an impact source bombardment space 114 through which the impact source 12 and the elastic connector 13 pass; and fixators 115 are respectively disposed on two opposite sides of an inner wall of the frame 111.

The impact source 12 is provided with a through hole through which the elastic connector 13 passes.

A middle portion of the elastic connector 13 passes through the through hole in the impact source and is fixed to the impact source 12, and two ends of the elastic connector 13 are respectively connected to the fixators 115 on the inner wall of the frame 111.

The transducer 14 is disposed at a periphery of the fixed mount 11, wherein one end of the transducer 14 abuts against a surface of the medium to be tested 10, and another end is connected to the acquisition and analysis device 15; the transducer 14 is configured to measure impact echo data when the impact source 12 connected to the elastic connector 13 hits the surface of the medium to be tested 10, and to send the impact echo data to the acquisition and analysis device 15.

The acquisition and analysis device 15 is configured to analyze the received impact echo data to obtain an analysis result.

In the above-described impact echo detection system of the present disclosure, since the impact source is disposed in the middle of the fixed mount and the impact source is connected to the fixed mount through the elastic connector, when the impact echo detection is required, the impact source can firstly be pulled away from the fixed mount (e.g., pulling the impact source upwardly to a predetermined height). When impact source is pulled to a predetermined position, the impact source is released, so that the impact source is driven by the elastic connector to quickly hit the surface of the medium to be tested (instantaneous single contact) to generate an impact echo inside the medium. Since a longitudinal wave propagates the fastest, it will first reflect when it encounters a defect inside the medium. After the reflected wave reaches the surface of the medium, it will reflect again to the inside of the medium. The echo will gradually decay after multiple reflections. After receiving the repeatedly reflected wave, the transducer will form a periodic signal with a period that is related to a depth of the defect. The greater the depth is, the longer the period is. After the impact echo measured by the transducer is sent to the acquisition and analysis device, the acquisition and analysis device can analyze the received impact echo to obtain an analysis result, thereby detecting information about a specific position and size of the defect inside the medium.

Further, preferably, in a specific embodiment of the present disclosure, the impact source may be a steel ball having a diameter from 2 to 10 millimeters (mm).

In addition, preferably, in a specific embodiment of the present disclosure, the elastic connector may be a rubber band or other elastic connectors having elasticity.

In addition, preferably, in a specific embodiment of the present disclosure, one end of the fixator 115 distant from the elastic connector 13 passes through the frame 111 and is fixed to the frame 111 by an adjustable bolt 116; and the force borne by the connected elastic connector 13 is adjusted by the movement of the adjustable bolt 116 in the horizontal direction (e.g., the adjustable bolt can be turned to adjust the tightness of the connected rubber band).

In addition, preferably, in a specific embodiment of the present disclosure, one end of the factor is fixed to the adjustable bolt by welding or methods of the like.

In addition, preferably, in a specific embodiment of the present disclosure, a hook structure for fixing the elastic connector is disposed at a joint of the fixators and the elastic connector.

In addition, preferably, in a specific embodiment of the present disclosure, an end of the support rod connected to the frame is threaded, and is fixed to the frame by a nut. Therefore, after the support rod passes through the support rod through hole, the threaded portions of the rod body on the upper and lower sides of the frame can be respectively fixed by nuts. When detecting different medium structures, a length of the support rod can be adjusted by rotating the nut, thereby enabling convenient adjustment of a height of the overall fixed mount.

In addition, preferably, in a specific embodiment of the present disclosure, the transducer may be an acceleration sensor or a displacement sensor with high sensitivity and a high signal to noise ratio.

In addition, preferably, in a specific embodiment of the present disclosure, the acquisition and analysis device further comprises an acquisition box and an analyzer.

The acquisition box is configured to receive the impact echo data from the transducer and to send the received impact echo data to the analyzer.

The analyzer is configured to display the received impact echo data through a time domain curve and transform the time domain curve into a frequency domain curve based on the Fast Fourier Transform to determine a thickness of the medium to be tested and a wave speed of the impact echo; wherein the analyzer is further configured to receive parameters input by user.

In addition, preferably, in a specific embodiment of the present disclosure, the acquisition box is provided with a USB data acquisition card (DAQ). The USB DAQ is connected to the transducer, and is connected to the analyzer through a USB interface for receiving the impact echo data from the transducer and sending the received impact echo data to the analyzer.

In the technical solution of the present disclosure, the detection range of the above-mentioned impact echo detection system may be from 100 to 10000 mm, in other words, a depth of the medium to be tested may be from 100 to 10000 mm. A frequency range of the reflected wave is from 5 to 100 kHz, and the sampling frequency can be arbitrarily selected between 200 kHz (corresponding to a defect with a depth of 50 mm) and 10 kHz (corresponding to a defect with a depth of 1000 mm). In addition, preferably, in the technical solution of the present disclosure, in order to smooth the collected digital signal, the highest sampling frequency may be preset to be not less than 400 kHz in advance.

In addition, preferably, in a specific embodiment of the present disclosure, the fixed mount may be made of a stainless steel or other metal materials having sufficient rigidity, and a rust-proof treatment is performed on a surface thereof.

In summary, in the technical solution of the present disclosure, since the impact source is disposed in the middle of the fixed mount and the impact source is connected to the fixed mount through the elastic connector, when the impact echo detection is required, the impact source can firstly be pulled away from the fixed mount, and when the impact source is pulled to the predetermined position, the impact source is released, so that the impact source is driven by the elastic connector to quickly hit the surface of the medium to be tested (instantaneous single contact) to generate an impact echo inside the medium. The impact echo will first reflect when it encounters the defect inside the medium. After the reflected wave reaches the surface of the medium, it will reflect again to the inside of the medium. The echo will gradually decay after multiple reflections. After receiving the repeatedly reflected wave, the transducer will form a periodic signal with a period that is related to the depth of the defect. The greater the depth is, the longer the period is. After the impact echo measured by the transducer is sent to the acquisition and analysis device, the acquisition and analysis device can analyze the received impact echo to obtain an analysis result, thereby detecting the information about the specific position and size of the defect inside the medium. Moreover, the impact echo detection system of the present disclosure is of a simple structure, integrates simplicity and portability, and possesses excellent directivity.

It is to be understood that the present disclosure is not limited to the precise structures that have been described above and shown in the drawings, and various modifications and changes can be made without departing from the scope thereof. The scope of the present disclosure is limited only by the appended claims.

What is claimed is:

1. An impact echo detection system, which consists of the several apparatus as follow: a fixed mount, an impact source, an elastic connector, one or more transducers, and an acquisition and analysis device;
wherein the fixed mount comprises: a frame and support rods, wherein the support rods are fixed to the frame, which is passed through by the support rods; a bottom portion of the support rod abuts against a surface of a medium to be tested; a middle portion of the frame is provided with an impact source bombardment space through which the impact source and the elastic connector pass; and fixators are respectively disposed on two opposite sides of an inner wall of the frame;
wherein the impact source is provided with a through hole through which the elastic connector passes;
wherein a middle portion of the elastic connector is fixed to the impact source, which is passed through by the a middle portion of the elastic connector through the through hole, and two ends of the elastic connector are respectively connected to the fixators on the inner wall of the frame;
wherein the transducer is disposed at a periphery of the fixed mount, one end of the transducer abuts against a surface of the medium to be tested, and another end is connected to the acquisition and analysis device; the transducer is configured to measure impact echo data when the impact source connected to the elastic connector hits the surface of the medium to be tested, and to send the impact echo data to the acquisition and analysis device; and
wherein the acquisition and analysis device is configured to analyze the received impact echo data to obtain an analysis result.

2. The impact echo detection system according to claim 1, wherein one end of the fixator distant from the elastic connector passes through the frame, and is fixed to the frame by an adjustable bolt; and the force borne by the connected elastic connector is adjusted by a movement of the adjustable bolt in a horizontal direction.

3. The impact echo detection system according to claim 2, wherein a hook structure for fixing the elastic connector is disposed at a joint of the fixators and the elastic connector.

4. The impact echo detection system according to claim 1, wherein an end of the support rod connected to the frame is threaded, and is fixed to the frame by a nut.

5. The impact echo detection system according to claim 1, wherein the acquisition and analysis device further comprises: an acquisition box and an analyzer; the acquisition box is configured to receive the impact echo data from the transducer and to send the received impact echo data to the analyzer; the analyzer is configured to display the received impact echo data through a time domain curve and transform the time domain curve into a frequency domain curve based on the Fast Fourier Transform to determine a thickness of the medium to be tested and a wave speed of the impact echo; and wherein the analyzer is further configured to receive parameters input by user.

6. The impact echo detection system according to claim 5, wherein the acquisition box is provided with a USB data acquisition card (DAQ); the USB DAQ is connected to the transducer, and is connected to the analyzer through a USB interface for receiving the impact echo data from the transducer and sending the received impact echo data to the analyzer.

7. The impact echo detection system according to claim 1, wherein the transducer is an acceleration sensor or a displacement sensor.

8. The impact echo detection system according to claim 1, wherein the impact source is a steel ball having a diameter from 2 to 10 mm, and the elastic connector is a rubber band.

9. The impact echo detection system according to claim 1, wherein the fixed mount is made of a stainless steel.
